(19) United States
(12) Patent Application Publication
(10) Pub. No.: US 2015/0172478 A1
(43) Pub. Date: Jun. 18, 2015

(54) IMAGE PROCESSING APPARATUS, CONTROL METHOD THEREOF, AND PROGRAM

(71) Applicant: CANON KABUSHIKI KAISHA, Tokyo (JP)

(72) Inventor: Daiki TACHI, Kawasaki-shi (JP)

(21) Appl. No.: 14/557,911

(22) Filed: Dec. 2, 2014

(30) Foreign Application Priority Data
Dec. 16, 2013 (JP) 2013-259303

(51) Int. Cl. H04N 1/00; H04N 1/32

(52) U.S. Cl. CPC H04N 1/00114; H04N 1/32128; H04N 2201/3209; H04N 2201/3278; H04N 2201/0093

(57) ABSTRACT

The present invention provides an image processing apparatus that is capable of creating a single file by attaching a receiving information file to electronic data that is received, to thereby facilitate management of the electronic data.

In an image processing apparatus 100 having a function for transferring electronic data, in a case where receiving data (first electronic data) is in a file format that allows attachment of other electronic data thereto, the image processing apparatus 100 formulates a receiving information file (second electronic data) that contains transmitter information that was attached to the receiving data. The image processing apparatus 100 then attaches the formulated receiving information file to the receiving data in accordance with a previously set attachment method, and transfers the resulting electronic data file.

### BACKGROUND OF THE INVENTION

1. Field of the Invention

The present invention relates to an image processing apparatus, a control method for the image processing apparatus, and a program. More particularly, the present invention relates to technology for attaching electronic data that is formulated inside a device to received electronic data, and transferring the resulting electronic data.

2. Description of the Related Art

Data transmission and reception functions in image processing apparatuses such as a multifunction machine include a receive-and-transfer function that transfers received fax data or I-fax data to a server through a network in accordance with a condition (transfer condition) at the time of receiving the data. Items which can be described as a transfer condition of the receive-and-transfer function include, in the case of fax data, an originating source fax number, a sub-address, and a password, and in the case of I-fax data, a transmitter name (From), a transmission destination (To), and a subject matter (Subject) and the like. It is also possible to set a complete match or a partial match as a separate condition for each item. If the contents of these items that are registered in the apparatus as a transfer condition and the contents of transfer propriety items attached to the receiving data match, the receiving data is transferred by a designated method. Further, when transferring the receiving data, transmitter information is attached thereto, and the resulting data is transferred to the designated destination.

In this connection, electronic data formats include formats that enable attachment of other electronic data thereto. An example of such a format is a PDF (portable document format) file defined by ISO. Normally, electronic data can be attached to a file in such a format by executing an application on a personal computer.

In recent years, formulation of files is not just performed by applications on a personal computer, but is also frequently performed by image processing apparatuses that optically scan a document and formulate electronic data. A method has been proposed that utilizes a file attachment function of electronic mail to attach a file that was formulated by an image processing apparatus to an electronic mail, and to describe the relation between another file and the file that is attached to the electronic mail in the text of the electronic mail (Japanese Patent Application Laid-Open No. 2008-306294).

### SUMMARY OF THE INVENTION

However, when transferring is performed by means of a receive-and-transfer function of an image processing apparatus, transmitter information that is added to electronic data that the transfer destination receives is information relating to the image processing apparatus that is the transfer source, and not information relating to the initial transmitter. Therefore, there is the problem that information relating to the transmitter that transmitted the electronic data before transferring of the electronic data was performed by the image processing apparatus does not remain when the data is received on the receiving side.

In the above described Japanese Patent Application Laid-Open No. 2008-306294, although receiving information that is received by an image processing apparatus can be transferred as transfer data in the form of a plurality of files that include receiving data and receiving information data, in that case multiple files are transferred, and managing the files requires time and labor.

The present invention has been conceived in view of the above described problems, and an object of the present invention is to provide technology that is capable of creating a single file by attaching a receiving information file to received electronic data, and thereby facilitate management of the electronic data.

To achieve the above described object, an image processing apparatus of the present invention includes: a setting unit configured to set a transfer condition; a receiving unit configured to receive an image data; an acquiring unit configured to acquire information relating to the receiving, in response to the receiving of the image data by the receiving unit; a transmitting unit configured to transmit an image file containing the image data received by the receiving unit, based on the transfer condition set by the setting unit; a formulating unit configured to formulate an information file containing the information acquired by the acquiring unit; and an attaching unit configured to attach, to the image file, the information file formulated by the formulating unit, as an attachment file of the image file, wherein the transmitting unit transmits the image file containing the information file attached by the attaching unit.

According to the present invention, in a case where first electronic data that is received is in a file format that allows attachment of other electronic data thereto, second electronic data that contains transmitter information that was attached to the first electronic data is formulated. The second electronic data is then attached to the first electronic data according to a previously set attachment method, and the resulting electronic data file is transferred. It is thereby possible to transfer a single electronic data file that contains information regarding the transmitting source or originating source, and thus management of the electronic data can be facilitated.

Further features of the present invention will become apparent from the following description of exemplary embodiments with reference to the attached drawings.

### BRIEF DESCRIPTION OF THE DRAWINGS

FIG. 1 is a block diagram illustrating one example of the hardware configuration of an image processing apparatus according to an embodiment of the present invention.

FIGS. 2A and 2B are views that illustrate an example of a screen that is displayed on a GUI of the image processing apparatus, in which FIG. 2A illustrates a transfer condition setting screen for fax data, and FIG. 2B illustrates an enlarged partial view of the setting screen in FIG. 2A.

FIG. 3 is a view illustrating an example of a transfer condition setting screen for I-fax data that is displayed on the GUI of the image processing apparatus.

FIG. 4A is a flowchart illustrating the flow of a transfer process that is performed with respect to receiving data in the image processing apparatus.

FIG. 4B is a flowchart illustrating the flow of a transfer process that is performed with respect to receiving data in the image processing apparatus.

FIGS. 5A and 5B are views that illustrate an example of a receiving information file that is to be attached to receiving data, in which FIG. 5A illustrates a file in a case where the receiving data is fax data, and FIG. 5B illustrates a file in a case where the receiving data is I-fax data.

FIG. 6 is a flowchart illustrating details of a transfer condition searching process that is performed with respect to fax data in step S1007 in FIG. 4A.

FIG. 7 is a flowchart illustrating details of a transfer condition searching process that is performed with respect to I-fax data in step S1007 in FIG. 4A.

FIG. 8 is a view illustrating one example of a page data structure in which a receiving information file is attached.

### DESCRIPTION OF THE EMBODIMENTS

Preferred embodiments of the present invention will now be described in detail in accordance with the accompanying drawings.

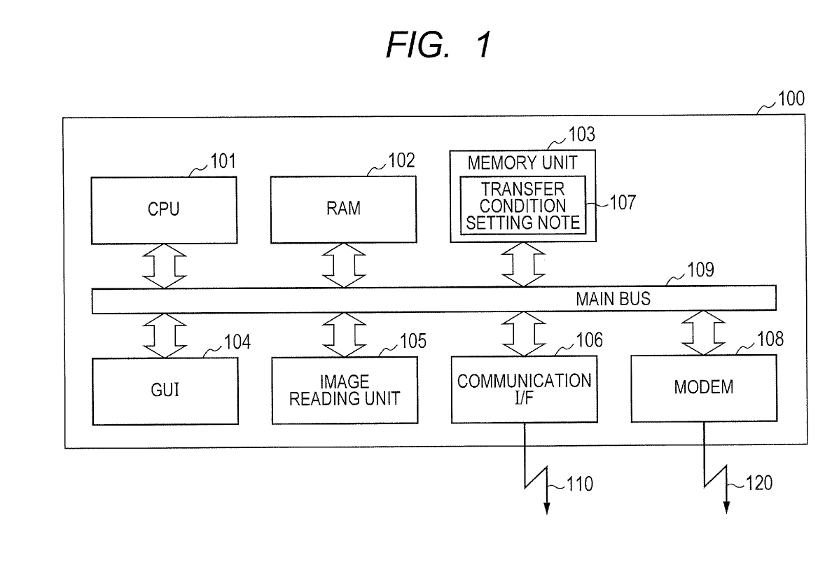

FIG. 1 is a block diagram illustrating one example of the hardware configuration of an image processing apparatus according to an embodiment of the present invention.

Reference numeral 100 denotes an image processing apparatus such as a multifunction machine. Reference numeral 110 denotes a communication line that connects to another device through a network. Reference numeral 120 denotes a PSTN line (public telephone line network) that connects to another device through a telephone line.

The image processing apparatus 100 includes the respective units that are described hereunder.

Reference numeral 101 denotes a CPU that controls the respective units illustrated in the drawing. Reference numeral 102 denotes a RAM that provides a work area for the CPU 101. Reference numeral 103 denotes a memory unit that stores programs, and also stores data of a transfer condition setting screen, various kinds of settings data of a transfer condition setting note 107, and files that are described later.

Reference numeral 104 denotes a GUI that displays a transfer condition setting screen that is described later, and accepts command inputs from a user. Reference numeral 105 denotes an image reading unit that optically reads a document and formulates electronic data. Reference numeral 106 denotes a communication I/F that controls transmission and reception of I-fax data through the communication line 110. Reference numeral 108 denotes a modem that transmits and receives fax data through the PSTN line 120. Reference numeral 109 denotes a main bus.

In the present embodiment, unless otherwise specified, the CPU 101 controls the RAM 102, the memory unit 103, the GUI 104, the image reading unit 105, the communication I/F 106 and the modem 108 through the main bus 109.

The image processing apparatus 100 includes a receive-and-transfer function for receiving electronic data via the communication line 110 or PSTN line 120 and transferring the electronic data to an external server (not illustrated in the drawings) or a personal computer (PC) via the communication line 110. The receive-and-transfer function transfers received fax data or I-fax data to a server and the like through the communication line 110 in accordance with transfer conditions that are previously set on a transfer condition setting screen that is described later.

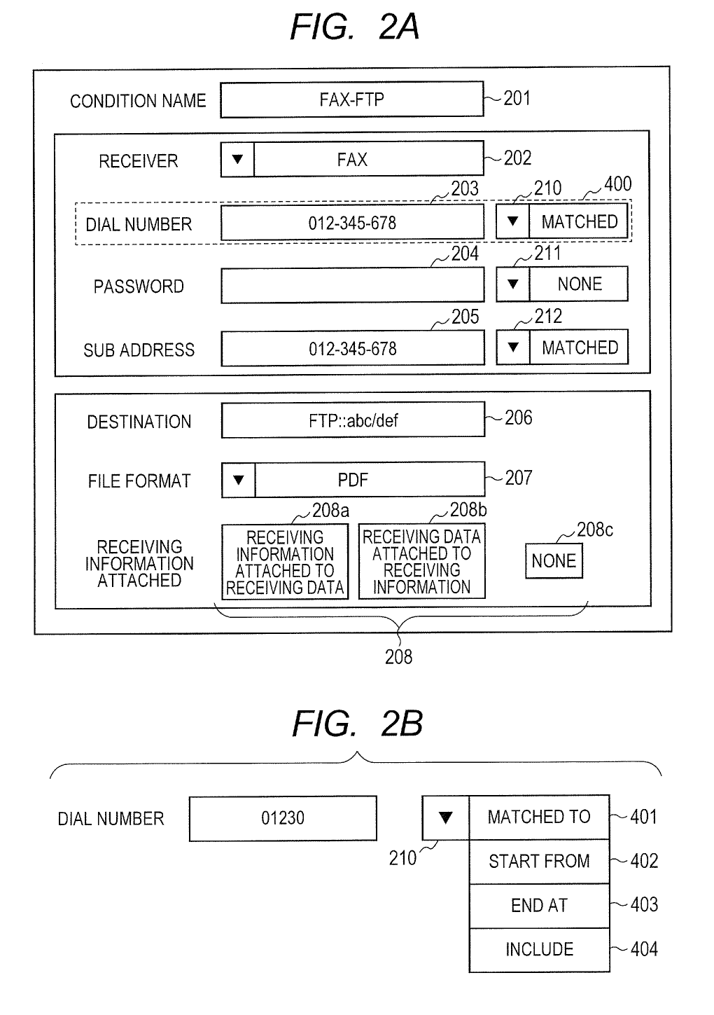

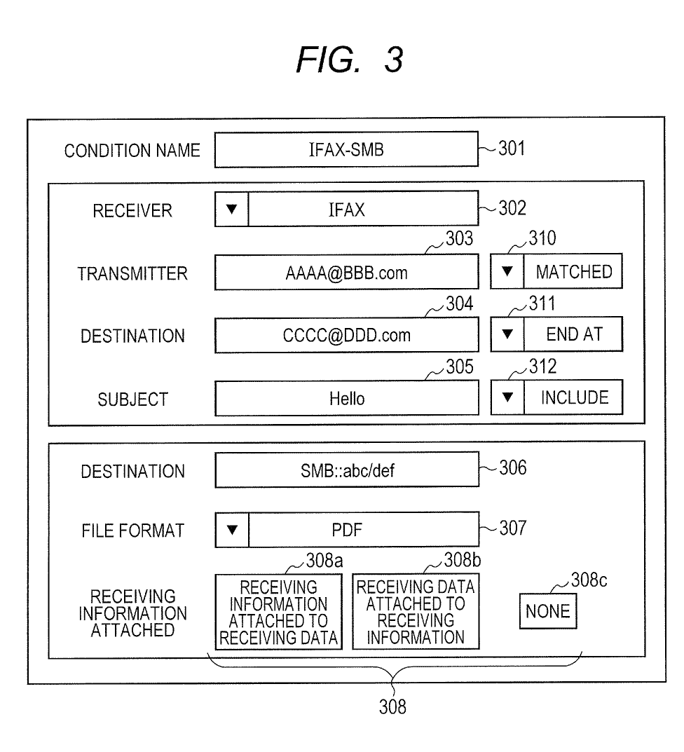

Next, a method for setting a transfer condition that is performed using the image processing apparatus 100 will be described referring to FIG. 2A, FIG. 2B and FIG. 3.

First, a transfer condition for the relevant receiving data for a time when the image processing apparatus 100 receives fax data is set on a transfer condition setting screen for fax data that is illustrated in FIG. 2A. A “condition name” setting portion 201, a “receiver” setting portion 202, a “dial number” setting portion 203 for the originating source, a “password” setting portion 204, and a “sub-address” setting portion 205 are arranged on the setting screen illustrated in FIG. 2A. In addition, a “destination” setting portion 206 and a “file format” setting portion 207 are arranged on the setting screen.

In FIG. 2A, “FAX-FTP” is set in the “condition name” setting portion 201. “FAX” is set as the receiving unit in the “receiver” setting portion 202. With respect to the method of setting the receiving unit, a receiving unit can be selected and specified by means of a pull-down button, without requiring key entry. A dial number “012-345-678” of the originating source is set in the “dial number” setting portion 203. A password is set as required in the “password” setting portion 204. A sub-address “012-345-678” of the originating source is set in the “sub-address” setting portion 205.

In the “destination” setting portion 206, “FTP::abc/def” is set as the transfer protocol, server name and folder and the like of the transfer destination. In the “file format” setting portion 207, the file format “PDF” is set as the format into which to convert the receiving data. With respect to the method of setting the file format, a format can be selected and specified by means of a pull-down button, without requiring key entry.

In a “receiving information attached” setting portion 208, an attachment method for attaching receiving information to receiving data can be selected from among three forms. The first form is “receiving information attached to receiving data”, the second is “receiving data attached to receiving information”, and the third is “none”. A user can set the attachment method for attaching the receiving information to the receiving data as a transfer condition by pressing any of buttons 208a, 208b and 208c.

Next, a transfer condition for the relevant receiving data for a time when the image processing apparatus 100 receives I-fax data is set on a transfer condition setting screen for I-fax data that is illustrated in FIG. 3. A “condition name” setting portion 301, a “receiver” setting portion 302, a “transmitter” setting portion 303, a “destination” setting portion 304, and a “subject” setting portion 305 are arranged on the setting screen illustrated in FIG. 3. In addition, a “destination” setting portion 306 and a “file format” setting portion 307 are arranged on the setting screen.

In FIG. 3, “IFAX-SMB” is set in the “condition name” setting portion 301. “IFAX” is set as the receiving unit in the “receiver” setting portion 302. With respect to the method of setting the receiving unit, a receiving unit can be selected and specified by means of a pull-down button, without requiring key entry. An address “AAAA@BBB.com” of the transmitter is set in the “transmitter” setting portion 303. An address “CCCC@DDD.com” of the destination is set in the “destination” setting portion 304. An arbitrary character string “Hello” as the subject is set in the “subject” setting portion 305.

In the “destination” setting portion 306, “SMB::abc/def” is set as the transfer protocol, server name and folder and the like of the transfer destination. In the “file format” setting portion 307, the file format “PDF” is set as the format into which to convert the receiving data. With respect to the method of setting the file format, a format can be selected and specified by means of a pull-down button, without requiring key entry.

In a “receiving information attached” setting portion 308, an attachment method for attaching receiving information to receiving data can be selected from among three forms. The first form is “receiving information attached to receiving data”, the second is “receiving data attached to receiving information”, and the third is “none”. A user can set the attachment method for attaching the receiving information to the receiving data as a transfer condition by pressing any of buttons 308a, 308b and 308c.

With respect to the items “dial number”, “password”, and “sub-address” on the transfer condition setting screen for fax data, and the items “transmitter”, “destination”, and “subject” on the transfer condition setting screen for I-fax data, the user can select and specify a complete match or a partial match by means of a pull-down button. For example, as shown in FIG. 2B, with respect to the “dial number” item, if the user presses a pull-down button 210, the items “matched to” 401, “start from” 402, “end at” 403, and “include” 404 are displayed as selection candidates. A complete match can be specified by selecting “matched to” 401. A partial match can be specified by selecting any one of “start from” 402, “end at” 403, and “include” 404.

With respect to the items “password” and “sub-address”on the transfer condition setting screen for fax data, by selecting “none” that is shown in FIG. 2A from selection candidates that are displayed upon pressing pull-down buttons 211 and 212, the user can specify to the effect that the corresponding item itself does not exist.

Note that, with respect to the “password” setting portion or the “sub-address” setting portion, the following operation is performed in a case where “none” is selected to specify to the effect that the item password or sub-address does not itself exist with respect to a transfer condition. That is, in a case where a password or a sub-address has been added to received fax data, or data to the effect that a password or a sub-address is “none” has been added thereto, the number of items will not match and transferring of the received fax data will be prohibited.

With respect to the “file format” setting portion, the file format can be selected in a case where the transfer destination is a destination for file transmission (SMB, FTP and WebDAV) or electronic mail transmission. (*WebDAV: Distributed Authoring and Versioning protocol for the WWW).

Selection of an item of the “receiving information attached” setting portion is enabled in a case where the selected file format is a PDF or Microsoft Office (registered trademark) file format that has a file attachment function.

The respective transfer conditions that are set on the above described two setting screens are stored in the memory unit 103 as the transfer condition setting note 107.

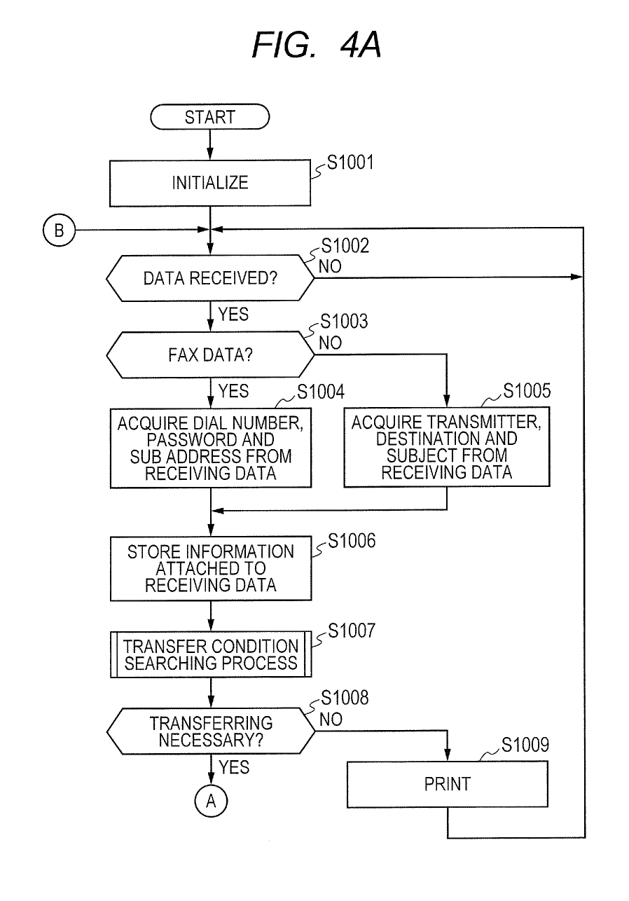

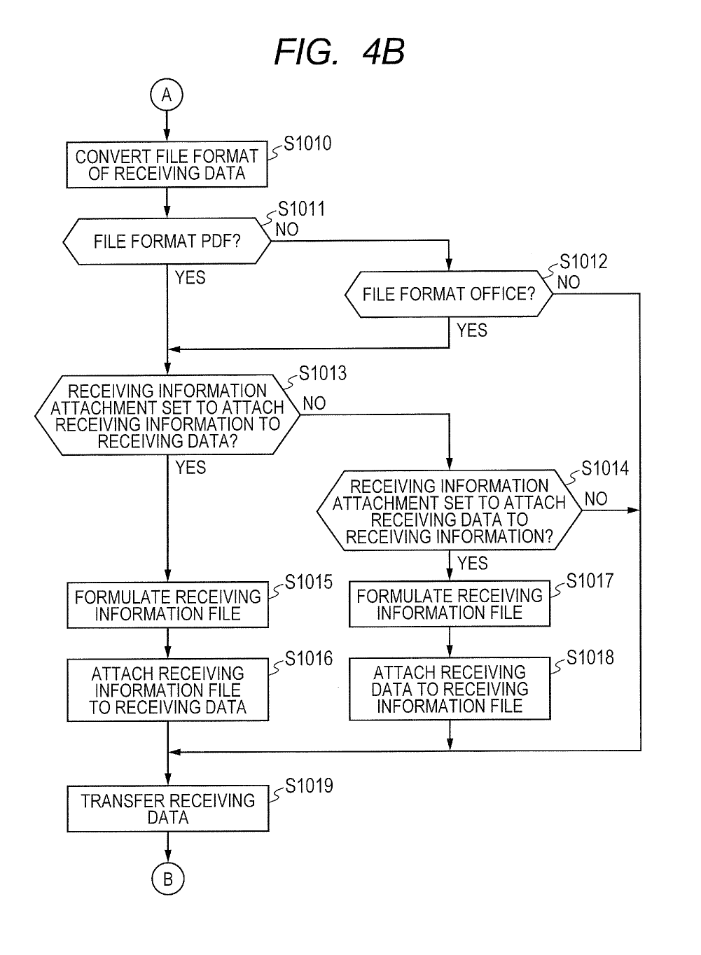

Next, the flow of a process to transfer receiving data that is executed by the image processing apparatus 100 after transfer conditions have been set in advance on the above described two setting screens will be described using FIG. 4A and FIG. 4B.

FIG. 4A and FIG. 4B are flowcharts that illustrate the flow of a process to transfer receiving data that is performed in the image processing apparatus 100.

In FIG. 4A, upon the power of the image processing apparatus 100 being turned on, the CPU 101 initializes the entire apparatus (step S1001).

Next, the CPU 101 waits for the communication I/F 106 or the modem 108 to receive data (step S1002). Upon the communication I/F 106 or the modem 108 receiving fax or I-fax data (Yes in step S1002), the CPU 101 determines whether or not the receiving data is fax data (step S1003).

In step S1003, if the CPU 101 determines that the received data is fax data from the modem 108, the CPU 101 acquires data such as the dial number of the originating source, the password, and the sub-address that were attached to the fax data (step S1004), and then proceeds to step S1006.

In contrast, if the CPU 101 determines in step S1003 that the received data is not fax data, the CPU 101 proceeds to step S1005.

In step S1005, the CPU 101 acquires header contents for the transmitter (From), destination (To), and subject (Subject) that are attached to the I-fax data received from the communication I/F 106, and then proceeds to step S1006.

In step S1006, the CPU 101 stores the reception type (FAX or I-FAX) of the received data as well as the information attached to the receiving data in the memory unit 103.

Next, as pre-processing for determining whether or not the receiving data should be transferred, the CPU 101 performs a searching process with respect to the transfer condition setting note 107 that is stored in the memory unit 103 (step S1007). The details of the transfer condition searching process in step S1007 are described later.

In step S1008, the CPU 101 determines whether transferring is necessary based on the result of the searching process with respect to the transfer condition setting note 107 that is stored in the memory unit 103. If the CPU 101 determines that transferring is not necessary, the CPU 101 proceeds to step S1009 to perform printing of the received data, and thereafter returns to step S1002 to wait for reception of data.

On the other hand, if the CPU 101 determines in step S1008 that transferring is necessary, the CPU 101 proceeds to step S1010 in FIG. 4B in which the CPU 101 converts the file format of the receiving data to the format that is set in the transfer condition setting note 107.

Next, in step S1011, the CPU 101 determines whether the file format into which the receiving data was converted is the PDF file format. If the CPU 101 determines that the file format into which the receiving data was converted is not the PDF file format, the CPU 101 determines whether the file format is the Microsoft Office file format (step S1012). If the file format into which the receiving data was converted is a format other than the PDF or Microsoft Office file format, the CPU 101 transfers the receiving data to the destination of the transfer condition setting note 107 (step S1019).

In contrast, if the file format into which the receiving data was converted is the PDF or Microsoft Office file format, the CPU 101 proceeds to step S1013. In step S1013, the CPU 101 determines if “receiving information attached to receiving data” is selected as the setting for “receiving information attached” in the transfer condition setting note 107.

In step S1013, if the setting for “receiving information attached” in the transfer condition setting note 107 is “receiving information attached to receiving data” (Yes in step S1013) and the reception type is FAX, the CPU 101 proceeds to step S1015.

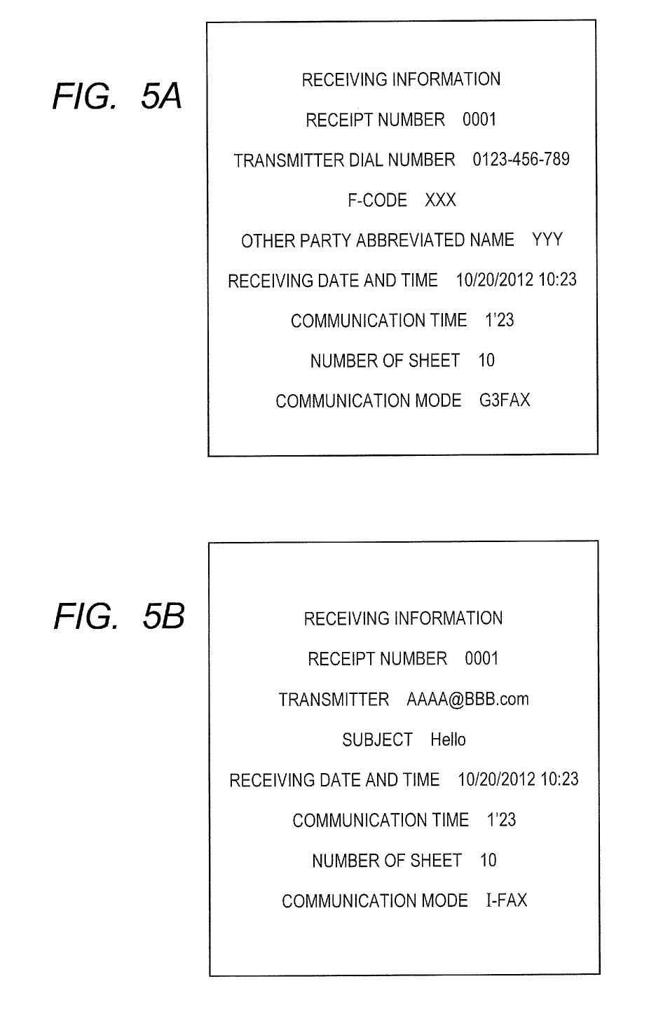

In step S1015, as illustrated in FIG. 5A, the CPU 101 formulates a receiving information file in which information such as a receipt number, the receiving date and time, and the receiving period as well as fax-specific information are described.

On the other hand, in step S1013, if the setting for “receiving information attached” in the transfer condition setting note 107 is “receiving information attached to receiving data” (Yes in step S1013) and the reception type is I-FAX, the CPU 101 proceeds to step S1015.

In step S1015, as illustrated in FIG. 5B, the CPU 101 formulates a receiving information file in which information such as a receipt number, the receiving date and time, and the receiving period as well as I-fax-specific information are described.

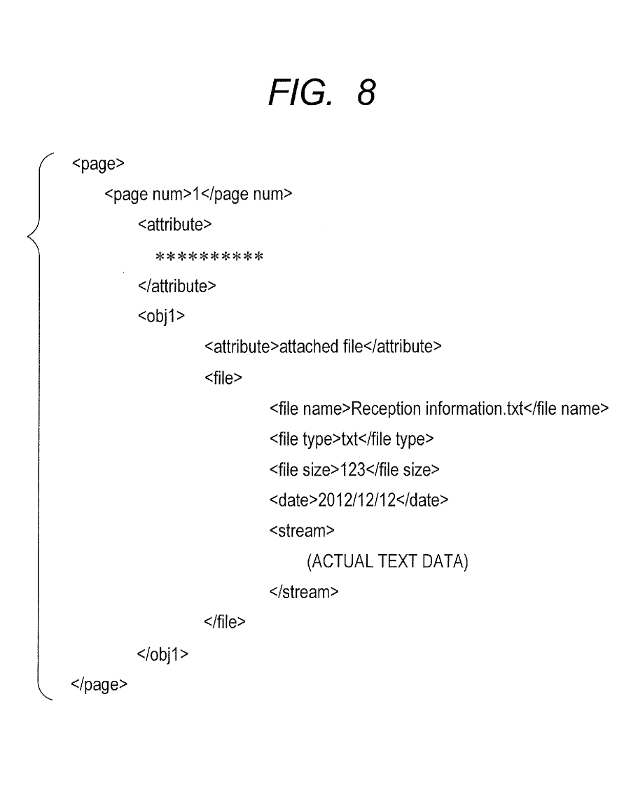

Next, in step S1016, the CPU 101 attaches the receiving information file formulated in step S1015 to the receiving data. An example of the page data structure in which the receiving information file is attached is illustrated in FIG. 8.

Next, in step S1019, the CPU 101 transmits (transfers) electronic data with respect to which file attachment was performed to the destination in the transfer condition setting note 107. After transmission is completed, the CPU 101 returns to step S1002 to wait for reception of data.

In steps S1013 and S1014, if the setting for “receiving information attached” in the transfer condition setting note 107 is “receiving data attached to receiving information” (No in step S1013 and Yes in step S1014) and the reception type is FAX, the CPU 101 proceeds to step S1017.

In step S1017, as illustrated in FIG. 5A, the CPU 101 formulates a receiving information file in which information such as a receipt number, the receiving date and time, and the receiving period as well as fax-specific information are described.

On the other hand, in steps S1013 and S1014, if the setting for “receiving information attached” in the transfer condition setting note 107 is “receiving data attached to receiving information” (No in step S1013 and Yes in step S1014) and the reception type is I-FAX, the CPU 101 proceeds to step S1017.

In step S1017, as illustrated in FIG. 5B, the CPU 101 formulates a receiving information file in which information such as a receipt number, the receiving date and time, and the receiving period as well as I-fax-specific information are described.

Next, in step S1018, the CPU 101 attaches the receiving data to the receiving information file formulated in step S1017. An example of the page data structure in which the receiving information file is attached is illustrated in FIG. 8.

Next, in step S1019, the CPU 101 transmits (transfers) electronic data with respect to which file attachment was performed to the destination in the transfer condition setting note 107.

In contrast, if “none” is selected with respect to attaching receiving information in the setting for “receiving information attached” of the transfer condition setting note 107, the CPU 101 transmits (transfers) the receiving data as it is to the transfer destination (step S1019).

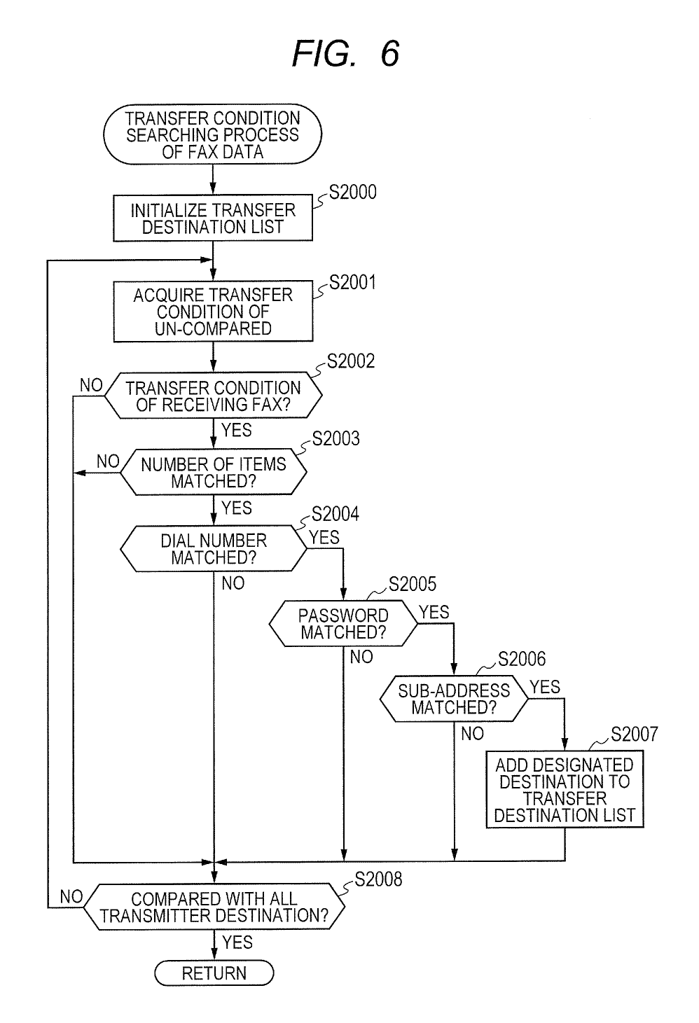

Next, details of the transfer condition searching process performed with respect to received fax data in step S1007 in FIG. 4A will be described using FIG. 6.

FIG. 6 is a flowchart illustrating details of the transfer condition searching process performed with respect to received fax data in step S1007 in FIG. 4A.

The CPU 101 initializes a transfer destination list that is stored in the memory unit 103 (step S2000).

Next, the CPU 101 acquires a transfer condition (for example, a transfer condition including a plurality of items that were set on the aforementioned transfer condition setting screen) that has not been compared with the receiving data, from the transfer condition setting note 107 stored in the memory unit 103 (step S2001).

Next, the CPU 101 determines whether the transfer condition of the transfer condition setting note 107 acquired from the memory unit 103 is a transfer condition relating to fax data (step S2002). If the transfer condition of the transfer condition setting note 107 acquired from the memory unit 103 is not a transfer condition relating to fax data, the CPU 101 determines whether a comparison has been performed with respect to all transfer destinations (step S2008).

On the other hand, if the transfer condition of the transfer condition setting note 107 acquired from the memory unit 103 is a transfer condition relating to fax data, the CPU 101 determines whether the number of items in the transfer condition is equal to the number of items for determining the transfer propriety that are attached to the received data (step S2003). According to the present embodiment, the number of items for determining the transfer propriety that are attached to the data are, in the case of fax data, the three items acquired in step S1004 in FIG. 4A, namely, the dial number, password, and sub-address. Note that, in a case where “none” is specified for an item of a transfer condition acquired from the transfer condition setting note 107, the relevant item is not counted as a transfer condition item. For example, in a case where a password has not been set, the number of items is two, and the number of items match in a case where the data acquired from the receiving data is the dial number and sub-address.

If the CPU 101 determines based on the result determined in step S2003 that the number of items in the transfer condition is not equal to the number of items for determining the transfer propriety that are attached to the received data, the CPU 101 proceeds to step S2008. On the other hand, if the number of items in the transfer condition is equal to the number of items for determining the transfer propriety that are attached to the received data, the CPU 101 proceeds to step S2004.

In step S2004, the CPU 101 determines whether the originating source dial number in the transfer condition acquired from the transfer condition setting note 107 completely matched or partially matched the originating source dial number attached to the received fax data. In this case, whether “matching” is determined with respect to a complete match or a partial match depends on the setting contents of the acquired transfer condition. In a case where “matched to” is set, the CPU 101 determines that the dial number matched only in a case where the dial number completely matched. In a case where “start from”, “end at”, or “include” is set, the CPU 101 determines whether the dial number partially matched based on the relevant setting contents.

If the dial number matched in step S2004, the CPU 101 executes steps S2005 and S2006. That is, the CPU 101 determines whether the password and sub-address acquired from the transfer condition setting note 107 completely match or partially match the password and sub-address attached to the fax data. If the CPU 101 determines that the password or sub-address does not match, the CPU 101 proceeds to step S2008.

If the CPU 101 determines that the number of items, dial number, password, and sub-address matched, the CPU 101 adds the transfer destination that is set in the acquired transfer condition to the initialized transfer destination list (step S2007).

In step S2008, the CPU 101 determines whether a comparison has been performed with respect to all the transfer conditions from the transfer condition setting note 107 stored in the memory unit 103 (step S2008). If the CPU 101 determines that a comparison has been performed with respect to all the transfer conditions, the processing Returns. On the other hand, if the CPU 101 determines that a comparison has not been performed with respect to all the transfer conditions, the CPU 101 returns to step S2001.

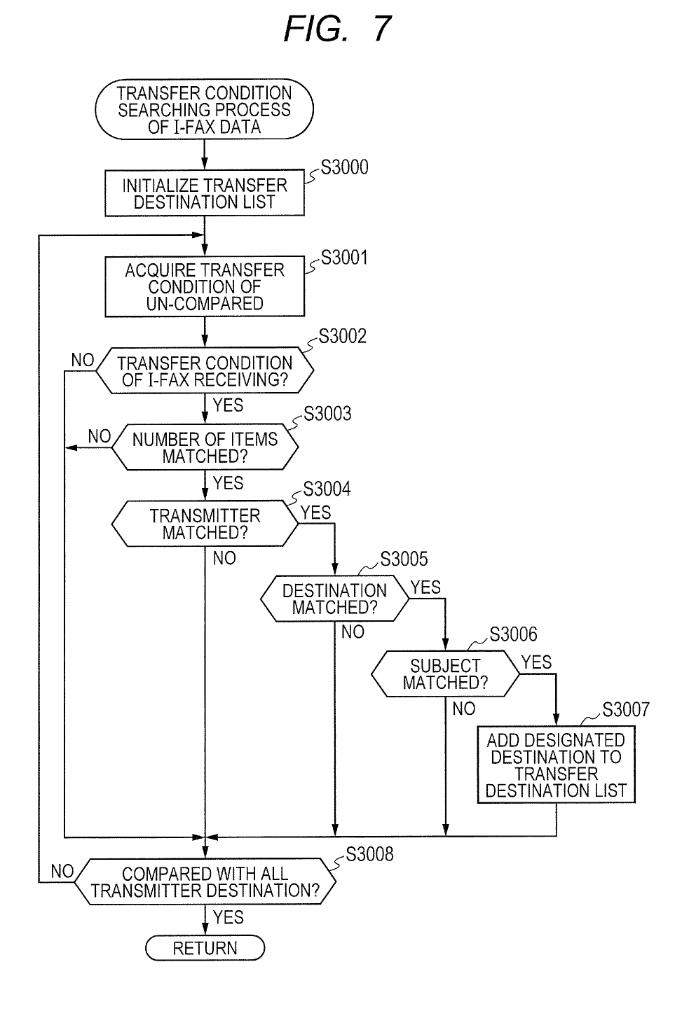

Next, details of the transfer condition searching process performed with respect to received I-fax data in step S1007 in FIG. 4A will be described using FIG. 7.

FIG. 7 is a flowchart that illustrates the details of the transfer condition searching process performed with respect to received I-fax data in step S1007 in FIG. 4A. Note that the process illustrated in FIG. 7 is approximately the same as the transfer condition searching process for fax data illustrated in FIG. 6, and hence only portions that are different to the process in FIG. 6 are described hereunder.

The CPU 101 initializes a transfer destination list that is stored in the memory unit 103 (step S3000).

Next, the CPU 101 acquires a transfer condition (for example, a transfer condition including a plurality of items that were set on the aforementioned transfer condition setting screen) that has not been compared with the receiving data, from the transfer condition setting note 107 stored in the memory unit 103 (step S3001).

Next, the CPU 101 determines whether the transfer condition of the transfer condition setting note 107 acquired from the memory unit 103 is a transfer condition relating to I-fax data (step S3002). If the transfer condition of the transfer condition setting note 107 acquired from the memory unit 103 is not a transfer condition relating to I-fax data, the CPU 101 determines whether a comparison has been performed with respect to all transfer destinations (step S3008).

On the other hand, if the transfer condition of the transfer condition setting note 107 acquired from the memory unit 103 is a transfer condition relating to I-fax data, the CPU 101 determines whether the number of transfer condition items is equal to the number of items for determining the transfer propriety in the header of the received data (step S3003). According to the present embodiment, the number of items for determining the transfer propriety attached to the data are, in the case of I-fax data, the three items acquired in step S1005 in FIG. 4A, namely, the transmitter, destination, and subject. Note that, in a case where “none” is specified for an item of a transfer condition acquired from the transfer condition setting note 107, the relevant item is not counted as a transfer condition item.

If the CPU 101 determines based on the result determined in step S3003 that the number of items in the transfer condition is not equal to the number of items for determining the transfer propriety in the header of the received data, the CPU 101 proceeds to step S3008. On the other hand, if the number of items in the transfer condition is equal to the number of items for determining the transfer propriety in the header of the received data, the CPU 101 proceeds to step S3004.

In step S3004, the CPU 101 determines whether the transmitter in the transfer condition acquired from the transfer condition setting note 107 completely matched or partially matched the transmitter in the header of the received I-fax data.

If the CPU 101 determines that the transmitter matched in step S3004, the CPU 101 then determines whether the destination and subject acquired from the transfer condition setting note 107 completely match or partially match the destination and subject in the header of the I-fax data (steps S3005 and S3006). If the CPU 101 determines that the destination or subject does not match, the CPU 101 proceeds to step S3008.

If the CPU 101 determines that the number of items, transmitter, destination, and subject matched, the CPU 101 adds the transfer destination that is set in the acquired transfer condition to the initialized transfer destination list (step S3007).

In step S3008, the CPU 101 determines whether a comparison has been performed with respect to all the transfer conditions from the transfer condition setting note 107 stored in the memory unit 103 (step S3008). If the CPU 101 determines that a comparison has been performed with respect to all the transfer conditions, the processing Returns. On the other hand, if the CPU 101 determines that a comparison has not been performed with respect to all the transfer conditions, the CPU 101 returns to step S3001.

According to the above described embodiment, in a case where receiving data (first electronic data) is in a file format that allows attachment of other electronic data thereto, the image processing apparatus formulates a receiving information file (second electronic data) that contains transmitter information that was attached to the receiving data. Further, the image processing apparatus attaches the formulated receiving information file to the receiving data in accordance with a previously set attachment method, and transfers the resulting electronic data file. It is thereby possible to transfer a single electronic data file that contains information regarding the transmitting source or originating source, and thus management of the electronic data can be facilitated. Note that the previously set attachment method is any one of a first attachment method that attaches a receiving information file to receiving data, a second attachment method that attaches receiving data to a receiving information file, and a method in which attachment is not performed.

In the above described embodiment, fax data and IP-fax data are taken as examples of data that is received. However, the relevant data may also be, for example, data that is received using a protocol such as SMB, FTP, WebDAV, or SMTP.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-259303, filed Dec. 16, 2013, which is hereby incorporated by reference herein in its entirety.

What is claimed is:

1. An image processing apparatus comprising:
a setting unit configured to set a transfer condition;
a receiving unit configured to receive an image data;
an acquiring unit configured to acquire information relating to the receiving, in response to the receiving the image data by the receiving unit;
a transmitting unit configured to transmit an image file containing the image date received by the receiving unit, based on the transfer condition set by the setting unit;
a formulating unit configured to formulate an information file containing the information acquired by the acquiring unit; and
an attaching unit configured to attach, to the image file, the information file formulated by the formulating unit, as an attachment file of the image file, wherein
the transmitting unit transmits the image file containing the information file attached by the attaching unit.

2. The image processing apparatus according to claim 1, further comprising
a setting unit configured to set as to whether the attaching by the attaching unit is performed or not.

3. The image processing apparatus according to claim 1, further comprising
a determining unit configured to determine as to whether the image file transmitted by the transmitting unit is in a predetermined format, wherein,
when the image file transmitted by the transmitting unit is determined as being in the predetermined format, the attaching unit attaches, to the image file, the information file.

4. The image processing apparatus according to claim 3, wherein,
when the image file transmitted by the transmitting unit is determined as being not in the predetermined format, the transmitting unit the image file to which the information file is not attached.

5. The image processing apparatus according to claim 3, wherein,
the predetermined format is PDF.

6. The image processing apparatus according to claim 1, wherein,
the information acquired by the acquiring unit contains information relating to a transmitting source of the image data or information relating to receiving time of the image data.

7. A controlling method of an image processing apparatus comprising:
setting a transfer condition;
receiving an image data;
acquiring information relating to the receiving, in response to the receiving the image data;
transmitting an image file containing the image date received, based on the transfer condition set;
formulating an information file containing the information acquired; and
attaching, to the image file, the information file formulated, as an attachment file of the image file, wherein
the image file transmitted contains the information file attached.

8. A non-transitory computer-readable storage medium storing a program that causes a computer to perform a method for controlling an image processing apparatus, the method comprising:
setting a transfer condition;
receiving an image data;
acquiring information relating to the receiving, in response to the receiving the image data;
transmitting an image file containing the image date received, based on the transfer condition set;
formulating an information file containing the information acquired; and
attaching, to the image file, the information file formulated, as an attachment file of the image file, wherein
the image file transmitted contains the information file attached.
